(19) United States
(12) Patent Application Publication
(10) Pub. No.: US 2014/0109437 A1
(43) Pub. Date: Apr. 24, 2014

(54) BOOT COVERS FOR BIG GAME HUNTING AND METHOD OF USING SAME

(71) Applicant: Eric J. Burr, Bennington, NE (US)

(72) Inventor: Eric J. Burr, Bennington, NE (US)

(21) Appl. No.: 14/047,580

(22) Filed: Oct. 7, 2013

Related U.S. Application Data
(60) Provisional application No. 61/716,954, filed on Oct. 22, 2012.

(51) Int. Cl. A01M 31/00

(52) U.S. Cl. CPC A01M 31/00
USPC 36/7.1 R

(57) ABSTRACT

A method and apparatus for hunting big game animals using boot covers of the type used in hospital surgery rooms to keep odors from a hunters boots from being transmitted to the ground or by wind currents. The boot covers are ideally treated with substances that are naturally occurring in the area where the big game are being hunted, examples being cedar oil, corn oil, soybean oil, acorn oil and/or urine from the species of big game animal being hunted.

### CROSS REFERENCE TO RELATED APPLICATIONS

This application claims the benefit of U.S. Provisional Patent Application Ser. No. 61/716,954 filed Oct. 22, 2012 entitled “Boot Covers for Big Game hunting and Method of Using Same ” and U.S. Patent Application Ser. No. 61/887,568, filed Oct. 7, 2013, to Burr, which are incorporated herein in its entirety.

### TECHNICAL FIELD

This invention relates generally to hunting big game and more particularly to creating a barrier between the ground and a hunters boots so that scent on a hunter's boots that is foreign to the outdoor area where hunters are hunting is not transmitted to the ground so that big game animals with a highly developed sense of smell are not alarmed.

### BACKGROUND

It is well known that deer, and many other big game animals, have a highly developed sense of smell. They can smell things that humans cannot. This is an inherent self-defense mechanism that they use to protect themselves from their enemies, such as hunters. For example if a hunter walks into the woods wearing boots that have been previously worn while the hunter was in the hunter's house, garage or vehicle, for example, the boots will usually have acquired scents that are common in those places but very uncommon in places where deer and other big game live. Petroleum oil on a garage floor, residual carpet cleaner on the carpet of a house or vehicle floor are just two examples of numerous smells/scents that could reside on the bottom of a hunter's boots that could be transferred to vegetation on the ground or on the ground itself in the woods and detected by the sensitive nose of a deer living in those woods.

Accordingly, good deer hunters often make an effort to prevent unnatural scent from getting on the bottom of their hunting boots. Some hunters do not wear their hunting boots except when they leave their vehicle to go hunting in the woods. Many wear rubber boots that are less porous and therefore less susceptible to gathering unnatural scents and which can be washed to help keep unnatural scents off of them. But hunters are still prone to walking in such rubber hunting boots in places where they can pick up unnatural odors that are undetectable by humans but detectable by big game. For example a hunter often wears his/her hunting boots when packing up hunting gear from a house or garage to put it in the vehicle he/she is driving to a place to hunt.

Accordingly, there is a need for a practical solution to this aforementioned problem.

### BRIEF DESCRIPTION OF THE DRAWINGS

The above needs are at least partially met through provision of the method and apparatus described in the following detailed description, particularly when studied in conjunction with the drawings, wherein:

FIG. 1 is a perspective view of a preferred embodiment of a boot cover constructed in accordance with the present invention;

FIG. 2 is a perspective view of the boot cover of FIG. 1 shown on a hunters boot;

FIG. 3 is a side elevational view of a hunter shown in dashed lines, with the boot covers of FIG. 1 on each of his boots, shown walking towards a tree;

FIG. 4 is a side elevational view of the hunter of FIG. 2, with the boot covers of FIG. 1 on each of his boots, shown walking towards the tree and showing a buck deer following in the hunters footsteps due to the smell of a substance, such as deer urine, applied to the boot covers;

FIG. 5 is a side elevational view of the hunter in a tree stand with his bow drawn in readiness to shoot a deer in the woods that has come within shooting range; and

FIG. 6 is a view of one of the boot covers being disposed on a branch in a tree to permit odor from substances applied to the boot cover to be blown from by wind currents for the purpose of either attracting big game or covering human scent of any hunter that would be standing in the tree stand shown in FIG. 6, the circled part of FIG. 6 being enlarged in a portion of FIG. 6.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

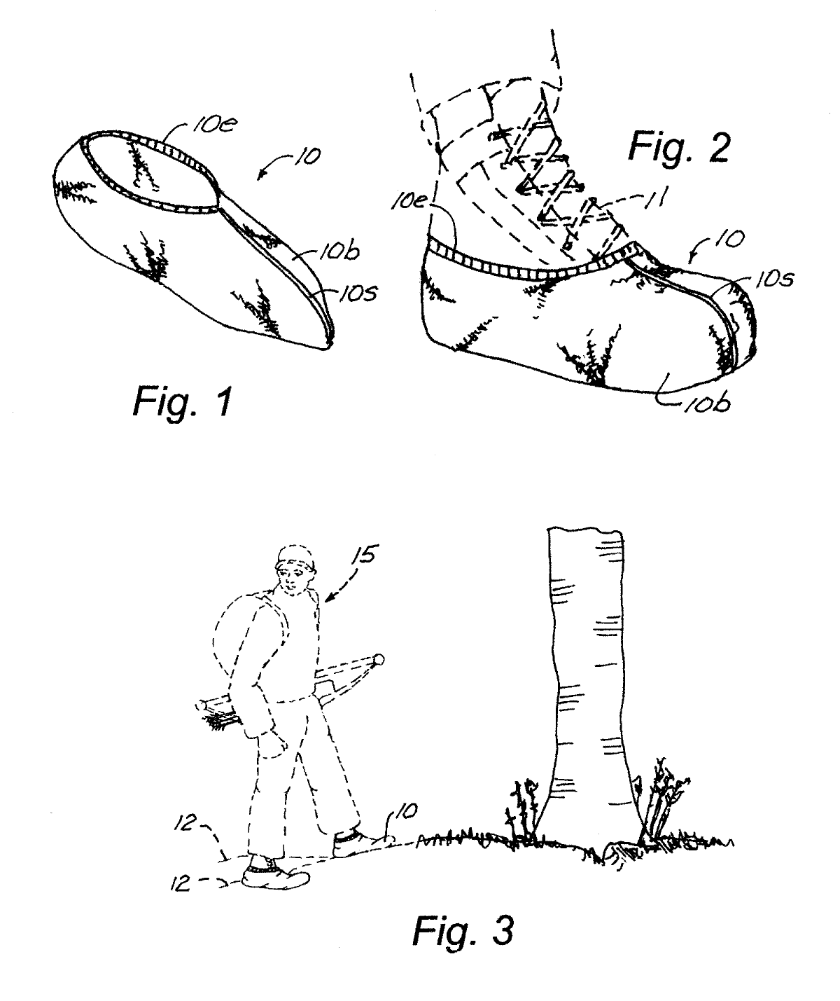

Referring now to the drawings, wherein like reference numerals indicate identical or similar parts throughout the several views, FIGS. 1-6 show a boot cover 10 constructed in accordance with a preferred embodiment of the invention. These boot covers 10 can be of many different types, but the preferred ones are of the type used by contractors, such has the “original ShuBee® brand shoe covers which are constructed of breathable cloth like material. Also useable for this purpose would be the shoe covers used by surgeons and nurses in hospitals, for example those that can be seen by the dozens by using a search engine on the internet and searching for “surgery shoe covers”. The ones that look like cloth but are made partially of a paper like material are ideal because of their low cost and because they will absorb liquids, the reason for which will be explained below. Some of these shoe covers are made from polypropylene fibers which can be of the “poly-spun” type that features spun bonded, 100% polypropylene fibers, but could be made of partly or wholly of nearly any kind of cloth, including naturally occurring materials such as cotton, wool, or paper; or any kind of man made fibers, including but not limited to, polypropylene, Nylon® or Rayon®. Of course any combination of such materials could be used as well.

Looking to FIGS. 1 and 2 it can be seen that the boot covers have a supple cloth like body portion 10b sewn together at a seam 10s. An elastic band 10e is sewn into an opening in the top of the boot cover 10 so that the boot cover 10 can be stretched over the bottom of a boot 12 as shown in FIG. 2 and the elastic band 10e will hold the boot cover 10 firmly in place as shown in FIG. 2.

Ideally the boot covers are porous and not waterproof, like rubber boot covers, so they can be saturated with a natural liquid substance such as cedar oil from cedar trees, or any other natural substance that would be in the woods where the big game animals to be hunted would naturally occur. If cedar trees are not naturally occurring in the area to be hunted then natural substances from other plants that naturally grow in that particular area would be used instead. Additionally, urine from an animal of the type being hunted can be applied to the boot covers as will be explained below. It is well known for example that deer and elk urine can be purchased at sporting good stores or on the internet.

There are three primary ways to use the boot covers 10 of the present invention for hunting purposes. The first way would be for the hunter to just put them on his/her boots just prior to entering the woods but after getting out of any vehicle that the hunter used to travel to the place to hunt. That way any substances on the bottom of the hunters boots from the hunter's home, garage, vehicle, etc. would be less likely to be transmitted to the ground as the hunter made his/her way through the woods. So a deer or other big game animal is less likely to know the hunter was there in the woods.

The second way the boot covers 10 of the present invention would be used for hunting purposes is to apply a natural substance of the type naturally occurring in the geographical area where the hunting is to occur, materials such as cedar oil, acorn odors, etc. This way when the hunter walks around through the woods, not only would the hunter's human odors be less likely to be transmitted to the ground, but such odors would be masked by the overwhelming smell of the natural substance applied to the boot covers 10.

The third way the boot covers 10 of the present invention would be used for hunting purposes is to apply a natural substance from an animal of the type naturally occurring in the geographical area where the hunting is to occur, materials such as deer or elk urine. This could be in addition to a natural substance like cedar oil if desired. Big game animals are often attracted by urine from their same species so they will often even follow a urine scent trail, which in this case could be from the hunter just walking through the woods with the boot covers 10 with urine on them.

During the breeding season (rut), big game animals, especially the male of the species, are often attracted to urine smells of the female and this is pronounces when for example a doe deer is in estrus. So “doe in heat” or doe in estrus urine can be applied to the boot covers 10 during the breeding season to add to the effectiveness of attracting bucks to follow where the boot covers 10 have traveled.

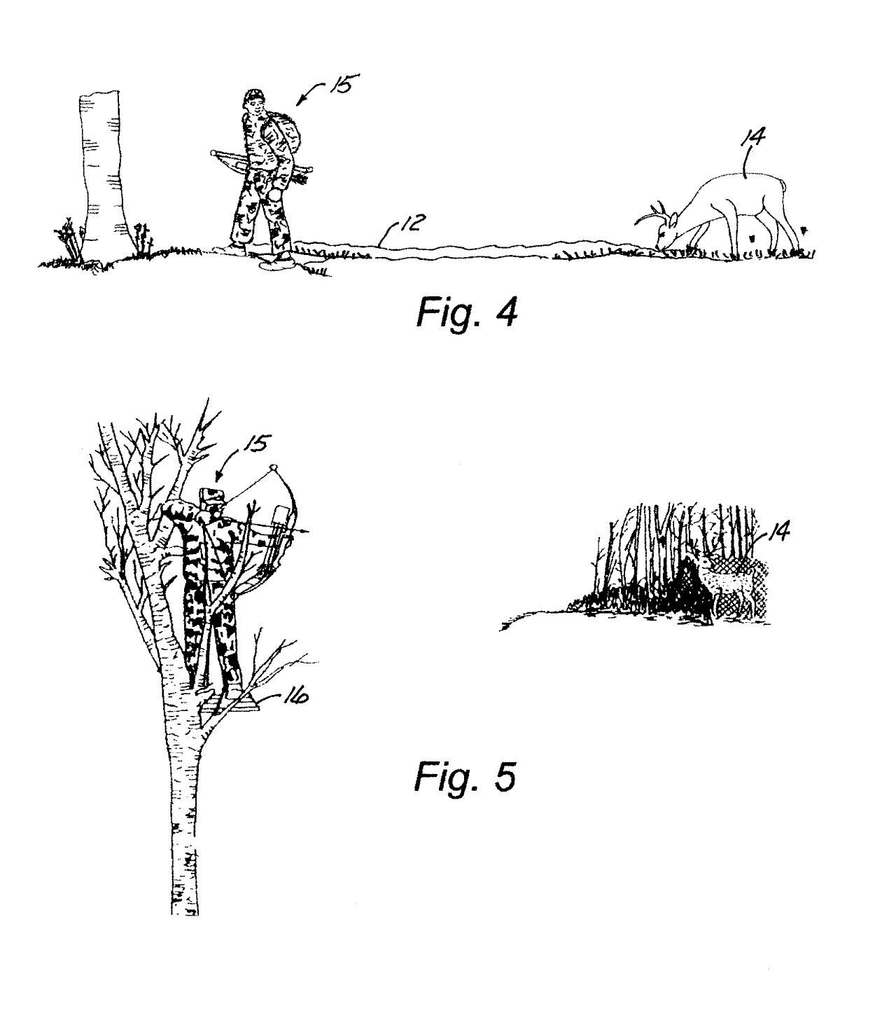

So looking at FIGS. 3 and 4, the lines 12 are shown to illustrate where wind currents might cause the smell of whatever the boot covers 10 are soaked into to travel along the ground. So if a buck 14 were to smell the odor of traveling along the lines 12, he would likely follow the scent which could perhaps lead the buck 14 to come within bow or gun range of the hunter 15, as shown for example in FIG. 5.

The boot covers 10 could be different for the pre-rut and late season than those for the rutting season. The boot covers for the rut would ideally have estrus doe urine or buck urine on them. Boot covers 10 used during the pre-rut would have doe urine (non-estrus), buck urine and cover scent. In the late season, the boot covers 10 would ideally just have a cover scent on them such as cedar oil, soy oil, corn oil or possibly some other food scent essential oils, for example.

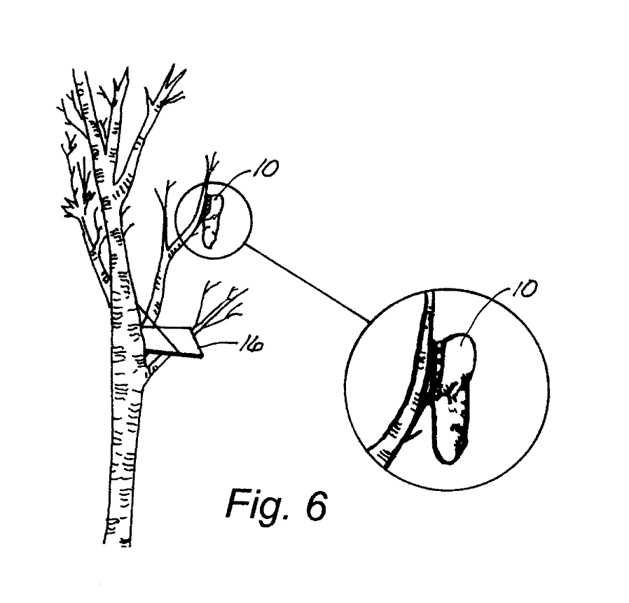

Looking to FIG. 6, the boot covers 10 can be hung on a branch in the tree while the hunter 15 is present on a tree stand 16. If a cover scent is on the boot covers 10, then that will help to “cover” up any human scent that might emanate from the hunter or smells from soaps, tooth paste, deodorants, shampoo or the like that would spook a deer if not covered up by the “cover scent” applied to the boot covers 10. Similarly, deer urine also would operate to cover the scent of the hunter, so hopefully any human smells would be overwhelmed by a pungent deer urine odor which would not alarm any deer smelling it, but would actually attract the deer to the location of the boot covers 10 shown in FIG. 6.

Ideally the boot covers 10, if treated with a cover scent or animal urine, could be packaged for sale in a ZIP-LOC ® type re-sealable plastic bag, but preferably sealed in a package in which the top also needs to be cut, torn or ruptured first before the re-sealable part is accessible. These types of packages are common for packaging food, such as nuts, where the consumer needs to know that the package has not previously been opened.

The boot covers 10 will sometimes be packaged with an Estrus Drip Wick container as shown in U.S. Patent Application Ser. No. 61/887,568, filed Oct. 7, 2013, to Burr, which application is incorporated herein in its entirety, so that a user can apply the “thickened” doe estrus to put on their boot covers 10. The thickened estrus will evaporate much slower than regular urine and absorb and remain in the fabric of the shoe covers better.

The boot covers 10 can also be used as an ideal scent containment product for setting and checking traps for trappers.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept as expressed by the attached claims.

I claim:

1. A method of hunting big game animals comprising:
placing disposable boot covers of the type used in medical surgery room on the hunters boots prior to walking into the woods where the big game are to be hunted.

2. The method of claim 1 including applying a substance to the boot covers, the substance being of a type which is naturally occurring in the woods of the geographical area where the hunter will be hunting.

3. The method of claim 2 wherein the substance is a cover scent obtained from plants.

4. The method of claim 2 wherein the substance is urine from the species of animal that is being hunted.

5. The method of claim 4 wherein the urine is from a male of the species.

6. The method of claim 4 wherein the urine is from a female of the species.

7. The method of claim 4 wherein the urine is from a female of the species during estrus.

8. The method of claim 1 wherein the boot covers comprise polypropylene fibers.

9. The method of claim 1 wherein the boot covers are constructed of a material which will absorb liquids.

10. The method of claim 1 wherein the boot covers are not constructed of a waterproof material.

11. The method of claim 1 wherein the boot covers are not constructed of rubber.

12. A boot cover for use in hunting big game comprising:
a liquid absorbent flexible cloth of a size and shape capable of covering the bottom and sides of a boot or shoe, said cloth having an opening in the top thereof, the top having an elastic member disposed therein for holding the boot cover on a boot or shoe.

13. The boot cover of claim 12 having a substance thereon which is naturally occurring in the woods of the geographical area where the hunter will be hunting.

14. The boot cover of claim 13 wherein the substance is a cover scent obtained from plants.

15. The boot cover of claim 13 wherein the substance is urine from the species of animal that is being hunted.

16. The boot cover of claim 15 wherein the urine is from a male of the species.

17. The boot cover of claim 15 wherein the urine is from a female of the species.

18. The boot cover of claim 15 wherein the urine is from a female of the species during estrus.

19. The boot cover of claim 13 wherein the boot covers comprise polypropylene fibers.

20. A boot cover for use in hunting big game comprising:
a flexible material of a size and shape capable of covering the bottom and sides of a boot or shoe, said material having an opening in the top thereof, the top having an elastic member disposed therein for holding the boot cover on a boot or shoe.
